(19) United States
(12) Patent Application Publication
(10) Pub. No.: US 2019/0186203 A1
(43) Pub. Date: Jun. 20, 2019

(54) GROUND ROD AND STAKE PULLER

(71) Applicant: TIM PRICE, D/B/A, CONTACT! CORPORATION, Winchester, VA (US)

(72) Inventors: Gary Andrew GROAH, Winchester, VA (US); Higinio F. MONTINI, Martinsburg, WV (US)

(21) Appl. No.: 16/099,567

(22) PCT Filed: Mar. 13, 2017
(86) PCT No.: PCT/US17/22180

§ 371 Date: Nov. 7, 2018

Related U.S. Application Data
(60) Provisional application No. 62/307,794, filed on Mar. 14, 2016.

(51) Int. Cl. E06C 7/12; B66D 1/04; B66D 1/12; B66D 1/36; E06C 1/22; E06C 1/397; E04H 17/26

(52) U.S. Cl. CPC E06C 7/12; B66D 1/04; B66D 1/12; E06C 7/423; E06C 1/22; E06C 1/397; E04H 17/265; B66D 1/36

(57) ABSTRACT

A ground rod and guy stake extractor according to the present approach overcomes many deficiencies of contemporary methods, and allows for the rapid extraction of ground rods and guy stakes across a full range of environments, and at a wide range of extraction angles, with a straight pull on the item being extracted. Embodiments may be lightweight, easily transported, and operated by a single individual. Embodiments may include a winch, winch cable system, and support structure. The geometry is such that it is easy and straight forward to align the direction of pull with any rod or ground stake, and particularly for those driven into the ground within the commonly prescribed angular limits, thus assuring a continuous, steady pull of at least four feet in most embodiments. Guy stakes can therefore be easily extracted in one step, and typically ground rods (because of their length) in two steps.

### CROSS REFERENCE TO RELATED APPLICATIONS

This application claims the benefit of U.S. Provisional Patent Application No. 62/307,794, filed Mar. 14, 2016, and incorporated by reference in its entirety.

### STATEMENT REGARDING GOVERNMENT SUPPORT

None

### FIELD

The present disclosure relates to an improved ground rod and guy stake puller for tactical military, temporary, or emergency communications and electronics equipment.

### BACKGROUND

Temporary, emergency and tactical military communications and electronics equipment usually require the use of electrodes (ground rods) which help to protect personnel and equipment from electrical faults, power surges, and lightning strikes, while reducing circuit noise and other transmission interference. These ground rods, which are eight or more feet long, are driven into the ground practically to their full length to provide an efficient path to ground. Tactical military ground rods are often assembled from screw-together sections of convenient length (about 40 inches), which simplifies storage and installation. Ground rods may be installed from 45 degrees up to an angle of 90 degrees to the horizontal. Retrieval of ground rods is usually difficult, time consuming, and often requires significant physical effort.

When such tactical equipment includes masts or towers to elevate antenna or sensor systems, there may also be a need for a system of supporting guy ropes, usually anchored by guy stakes. Guy stakes are typically driven at an angle of 60 degrees to the horizontal. Again, these guy stakes, often having a buried length of around 30 inches, are often difficult and time consuming to extract

Currently, the military uses a specially-shaped slide hammer to drive and retrieve ground rods. During rod extraction, the slide hammer works on the principle of the momentum generated by the operator sliding the hammer forcibly and repeatedly upwards against a stop. Since the slide hammer weighs about 15 pounds, ground rod extraction requires considerable effort and endurance, especially in hard ground, where each blow may only move the 8-foot-long rod an inch or so. Although the slide hammer is used for emplacement as well as extraction of ground rods, it is not suitable for use with guy stakes.

To drive guy stakes, the military typically uses a sledgehammer. Military guy stakes are usually shaped so that the sledge hammer may also be used to extract the stakes, using upwards blows. Both the driving and extraction of guy stakes with a sledge hammer requires considerable effort and time. Thirty-meter masts in widespread use with the US military are anchored with twelve stakes, requiring a total of 30 feet of steel to be manually driven or extracted. Although a sledge hammer is used for emplacement and extraction of guy stakes, it is not suitable for extraction of ground rods.

In addition to conventional slide hammers and sledge hammers, there are several commercially available ground rod pullers, and guy stake pullers. However, all suffer from draw backs in various degrees, and none provide safe, rapid, efficient retrieval of both ground rods and guy stakes by one person, across the full range of environments met with by the military.

Many previous art pullers are based on principles of operation originally conceived and intended to extract vertical fence and sign posts. These pullers are often awkward or impractical to use with guy stakes and ground rods which have been driven into the ground at an angle other than the vertical, as is usually the case in military applications.

Most commercially available pullers utilize a leverage principal, involving manual loads of one hundred pounds or more. This can be very demanding, especially in a military scenario, where a large number of items may need to be extracted in a very short time under extreme environmental conditions.

Most prior art leverage-principal pullers are not capable of providing a straight pull: the business end of the lever attached to the object being pulled describes a tight arc during operation, creating high bending loads on the object being withdrawn, increasing friction with the soil, and thus increasing the effort necessary for extraction. These loads also result in high risk of bending the stake or rod. Once extracted, a bent rod or guy stake cannot be driven into the ground again and must be discarded.

The design of many high leverage pullers is such that they operate in small steps, in some instances requiring resetting after each step, thus substantially increasing the time necessary to extract ground rods or guy stakes.

Many conventional pullers are not designed to be stable and self-supporting; they topple over if not held by the operator. Two operators may be required to extract stakes or ground rods in very hard or frozen ground, where it may be necessary to utilize the full pulling force generated by the device while simultaneously applying encouraging side-blows to the exposed part of ground rod or stake with a sledge hammer.

Many conventional pullers are awkward—or even unsafe—to use on sloping ground because they rely on high physical effort in situations where it may be difficult to keep one's balance.

Some commercial hydraulic-powered rod pullers are available. In general, these are not suited to military applications because of their high weight, precluding use by one person, and by their complexity and need for snag-prone hoses, inappropriate in many situations in the field.

At least one commercially available mechanical puller utilizes a traveler on a threaded spindle (an actuator in reverse). However, this equipment is only available with a short travel, creating the need for a multi-step operation, with laborious repositioning of the traveler after each short stroke.

What is now needed is a lightweight robust ground rod and guy stake puller which overcomes the many drawbacks of prior art. In particular, a ground rod and guy stake puller suited for repeated, very low effort one-person operation in the full range of adverse military environments (including sloping or uneven ground), and capable of rapid extraction of ground rods and guy stakes driven at any angle between 45 and 90 degrees to the horizontal without damaging them.

### BRIEF SUMMARY

This disclosure relates to embodiments of a ground rod and guy stake extractor. Embodiments of the present approach overcome many deficiencies of contemporary methods, including those identified above. For example, the present approach allows for the rapid extraction of ground rods and guy stakes across a full range of environments, and at a wide range of extraction angles, with a straight pull on the item being extracted. Embodiments may be lightweight, easily transported, and operated by a single individual.

Embodiments may be comprised of a winch, winch cable system, and support structure such as a strong, lightweight support structure, such as a tripod or A-frame. The winch may be mounted to the support structure in a variety of manners. For example, the mounting may be via a plate such that the winch handle may be turned fully in either direction without interference with the structure, while being at a convenient height for use by a standing operator. In some embodiments the winch may be removably attached, for ease of storage and transportation, as well as to maximize the utility of system components. For example, some embodiments may take the form of a mounting system configured to connect to an existing support structure, such as an adjustable ladder, and mount a winch to the support structure. In embodiments of the present approach, the winch cable may be routed over a pulley at the top of the support structure and then down to ground level between the legs of the structure. The cable may be terminated at its lower extremity with a hook to attach to a ground rod or guy stake. The design geometry is such that it is easy and straight forward to align the direction of pull with any rod or ground stake, and particularly for those driven into the ground within the commonly prescribed angular limits, thus assuring a continuous, steady pull of at least four feet in most embodiments. Guy stakes can therefore be extracted in one step, and ground rods (because of their length) in two steps.

Embodiments of a ground rod and stake extractor may include a support structure having an upper end with an articulable joint and a plurality of legs extending downward from the articulable joint, a winch assembly mounted to an upper portion of the support structure and including a winch; and a cable assembly operatively connected to the winch assembly and having an extraction segment extendable downward and configured for connection with at least one of a ground rod and a guy stake. The cable assembly may include a cable, a belt, or combinations thereof. In some embodiments, the winch assembly may be removably mounted to the support structure. Some embodiments may feature a winch assembly that includes a quick release strap for removably mounting the winch assembly to the support structure. The winch assembly in some embodiments may include a mounting plate mounted to the support structure and the winch connected to the mounting plate. The winch assembly may include a hand-operated winch, a motorized winch, and/or a winch capable of either manual operation or motorized operation. For example, a power drill or a removable hand crank may be used to operate a winch in some embodiments.

The support structure may be, in some embodiments, an extendible ladder, such as may be found at common hardware stores. In other embodiments, the support structure may take the form of a tripod with an A-frame connected to a strut at the articulable joint. If should be appreciated that a variety of support structures may be used without departing from the present approach.

In some embodiments, each leg includes a lower end opposite the articulable joint, and the cable assembly extraction segment is extendable downward from the winch assembly within an area defined by the legs' lower ends. This allows the cable assembly extraction segment to extract a ground rod or stake positioned within the area and take full advantage of the benefits described herein. The cable assembly's extraction segment in some embodiments may be connected to one of a snap hook and a soft link. A soft link may be a loop formed from an ultra-high molecular weight polyethylene material In some embodiments, a leg adjustable at the articulable joint between 0° and about 350° relative to another leg. This adjustability allows the embodiment to be adjusted for use in a variety of situations in which ground may not be level, or the extraction angle is extreme. In some embodiments, at least one leg is extendible in a direction away from the articulable joint. The cable assembly's extraction segment in some embodiments may be connected to a load-bearing clip connected to a soft link formed from an ultra-high molecular weight polyethylene material.

Some embodiments may include at least one wheel connected to at least one leg. This permits the embodiment to be collapsed at the articulable joint and easily transported, and allows some embodiments to function as a wheelbarrow or similar transport device. A variable brace may be included in some embodiments to adjustably secure a first leg relative to a second leg.

The winch assembly in some embodiments may be configured for looping a cable in a Vee configuration. For example, the winch assembly may have an upper surface with a connection point on a first side and an upper pulley on a side opposite from the first side. The cable assembly may extend from the upper pulley downward to a lower pulley positioned between the upper pulley and the connection point when viewed from above, the cable assembly further extending upward from the lower pulley such that a cable assembly free end connects to the connection point. As discussed below, this configuration provides various advantages. Some embodiments may include a safety disc on the cable assembly to prevent sudden whipping and control movement during extraction.

The present approach may also take the form of a method for extracting one of a ground rod and a guy stake. Generally, a support structure may be positioned over one of a ground rod and a guy stake. The support may have, for example, an articulable joint and a plurality of legs extending downward from the articulable joint, each leg with an end opposite the articulable joint such that the leg ends define an extraction area, the one of a ground rod and a guy stake extending at an extraction angle from the ground within the extraction area. The cable assembly's extraction segment may be connected to the one of a ground rod and a guy stake. The cable assembly may extend from a winch assembly mounted to an upper portion of the support structure. If necessary, at least one leg may be adjusted (e.g., length or position), such that the at least one leg's angle relative to the ground is approximately the extraction angle. This permits a straight pull on the ground rod or guy stake. The winch assembly may then be operated to extract the one of a ground rod and a guy stake at the extraction angle. It should be appreciated that deviations may be made without departing from the present approach.

### DESCRIPTION OF THE DRAWINGS

FIG. 1 shows an isometric view of an embodiment of the present approach.

FIG. 2 shows a front view of an embodiment of the present approach.

FIG. 3 shows a side view of an embodiment of the present approach extracting a guy stake.

FIGS. 4A-4C shows an alternative embodiment of a puller from (A) a front view, (B) a side view, and (C) a perspective view.

FIG. 5 shows an embodiment of a quick release device.

FIGS. 6A-6C show demonstrative steps for attaching an embodiment of a quick connection device to a guy stake.

FIGS. 7A and 7B show a collapsible embodiment according to the present approach.

FIG. 8 shows a preferred embodiment of the present approach wherein the support structure is an extending stepladder.

FIG. 9 shows a winch assembly according to a preferred embodiment of the present approach without its support structure.

FIG. 10 is a side view of a preferred embodiment being used to extract a guy stake driven at 60 degrees to the ground.

FIG. 11 is a side view of a preferred embodiment being used to extract a ground rod driven at 90 degrees to the ground.

FIG. 12 is a side view of a preferred embodiment being used to extract a ground rod driven at 45 degrees to the ground.

### DESCRIPTION

The following description is of the best currently contemplated modes of carrying out an exemplary embodiment of the invention. The description is not to be taken in a limiting sense, and is made merely for the purpose of illustrating the general principles of the invention.

A hand winch and a cable system may be incorporated into a ground rod and guy stake puller system. Use of a winch provides high mechanical advantage while also permitting a continuous straight line pull force, overcoming the principle disadvantages of prior art.

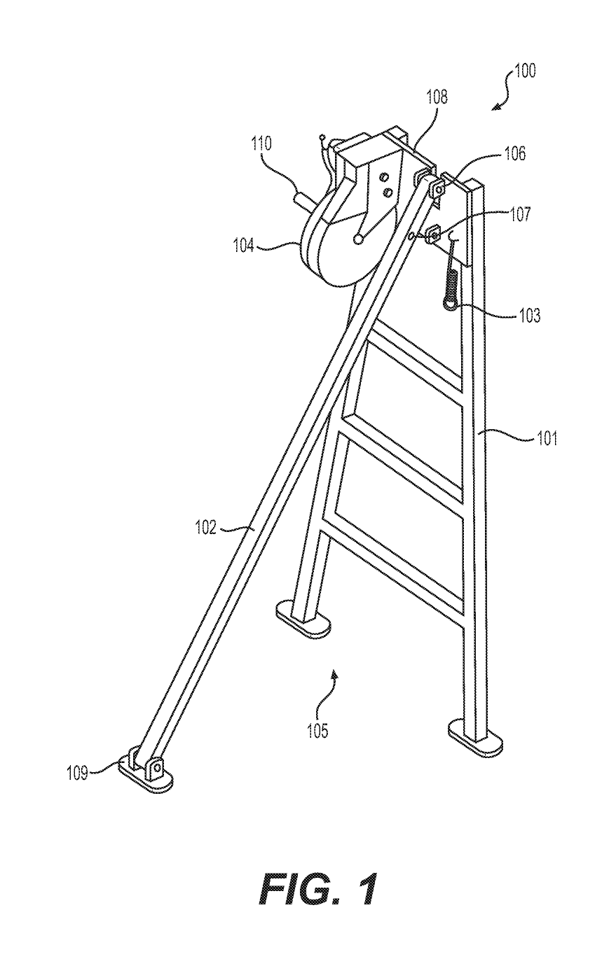

FIG. 1 shows an isometric view of an embodiment of the present approach, in which ground rod and stake puller 100 includes as support structure a tripod 105 supporting a winch 104. Tripod 105 in this embodiment is a foldable tripod having an A-frame 101 connected to a hinged strut 102, but it should be appreciated that a variety of support structures may be used without departing from the present approach. For example, several forms of articulable joints are known in the art that may be used. In this embodiment, hinge 106 is positioned at a top portion of A-frame 101, and is configured to allow strut 102 to fold from a maximum extended angle of about 340-350 degrees in some embodiments, and an operating apex angle of about 90 degrees in some embodiments, to flush against the A-frame 101. In some embodiments, the strut 102 may be secured at the desired apex angle with a variable brace (not shown in this view). To minimize the puller's storage space requirement, the strut 102 may be folded flush against the A-frame 101, and secured in the folded position by inserting quick release pin 103 into pin housing 107 of strut 102. Winch 104 is attached to cross-piece 108 at the top of the A-frame 101, although in some embodiments the winch may be attached at other locations. Also, some embodiments may feature a removable winch, configured for removably attaching a winch prior to use, and removing the winch after use (e.g., for storage and/or transportation). Preferably, this is also a quick release item. For example, in some embodiments winch 104 may include a pivoting lock latch that may engage one or more mounting bolts in A-frame 101. This approach allows winch 104 to be used for other purposes, such as operating a telescoping mast, and permits convenient storage between uses. Winch 104 may be powered by various mechanisms, and in this embodiment is powered by hand crank 110. Each leg of tripod 100 may include a foot 109. In some embodiments, one foot 109 or more may be hingedly mounted to a leg to provide an adjustable surface for use in various terrains.

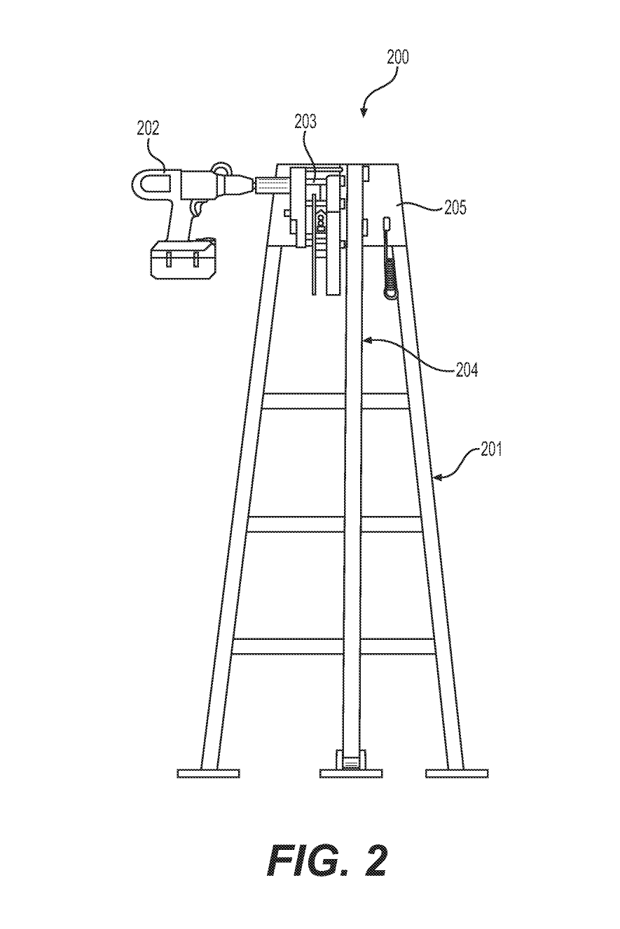

FIG. 2 shows a front view of an embodiment of the present approach. In this embodiment, puller 200 includes winch 203 mounted to tripod 201. Instead of a hand crank, cordless power drill 202 is used to power winch 203. Of course, other devices may be used to power winch 203 as will be appreciated by those skilled in the art. This embodiment also features strut 204 mounted to cross-piece 205 in an off-center manner, thereby offsetting the imbalance that may arise due to the mounting location of winch 203. It should be appreciated that the winch mounting location, and thus the strut mounting location, may vary in other embodiments without departing from the present approach.

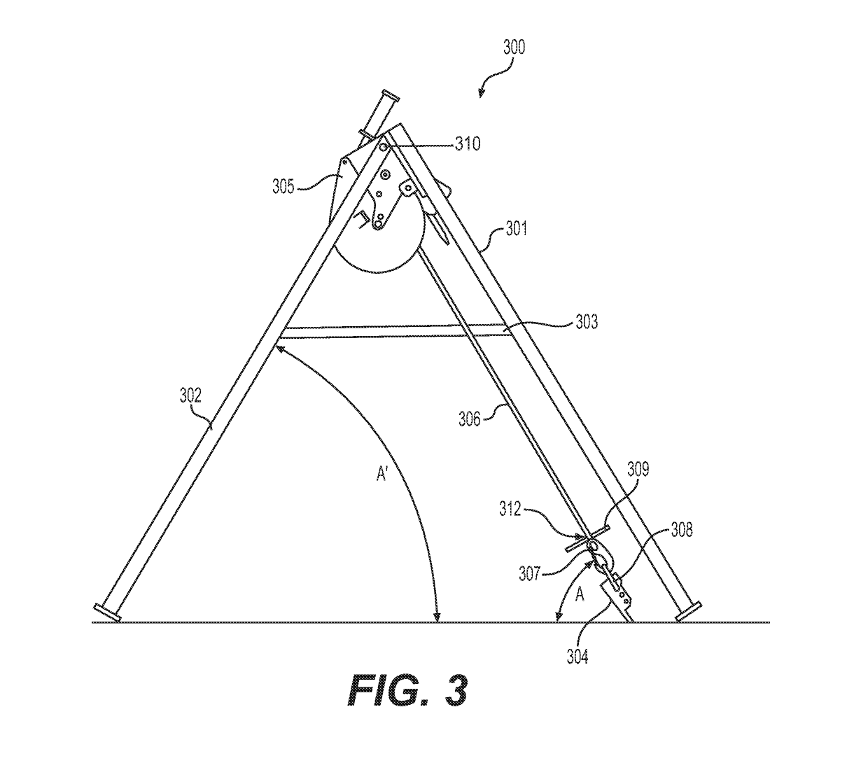

FIG. 3 shows a side view of an embodiment of the present approach. In this embodiment, puller 300 is extracting a guy stake 304 inserted into the ground at an angle A. Puller 300 includes winch 305 mounted to A-frame 301. Strut 302 is connected to A-frame 301 at hinge 310, and is extended from A-frame 301 such that the angle A′ from strut to ground is approximately the same as angle A. As a result, this embodiment approximates an equilateral triangle formed from the A-frame, strut, and ground.

Some embodiments may include one or more notional braces 303 between strut 302 and A-frame 301. A brace 303 may be adjustable in length, such that it can accommodate a wide range of angles A′. In other embodiments, brace 303 may be configured for re-locating higher or lower along the strut 302 and A-frame 301. For example, strut 302 and A-frame 301 may include a series of notches or slits for edges of a brace 303 to insert into and lock in place. In other embodiments, the braces may be permanently attached to the strut 302, and pass along either side of the hoisting belt 311 before attaching to the A-frame 301. The attachment may be with one or more quick release fittings. For example, in some embodiments, a quick release pin having one or more ball detents actuated by a push button may be used. Of course, it should be appreciated that the relative locations of a permanent and quick release attachment can be reversed. Generally, the brace 303 may be used to prevent the strut 302 and A-frame 301 from spreading outwards under load, whilst simultaneously providing the operator with a rapid means to set the legs of the tripod at the desired angle A′. For example, depending on the approximate angle of the ground rod or guy stake, an operator may seek to set angle A′ to approximately 75 degrees, 60 degrees, or 45 degrees, relative to the ground. Some embodiments with an adjustable brace 303 may include markings along the strut 302 and/or A-frame 301 to indicate the angle.

During operation, the puller 300 is positioned by the operator such that the feet of A-frame 301 are astride and just beyond the guy stake 304, such as shown in FIG. 3. The operator then unwinds belt (or cable) 306 from the winch 305. Typically, the belt 306 is unwound until the free end 312 of the belt 306 is adjacent to the stake (or rod) 304. Free end 312 may be attached to a snap hook 308 (or other clipping device as is known in the art), and snap hook 308 may be connected to a soft link 307. Generally, soft link 307 in this embodiment is formed from a loop of Dyneema®, which has the same strength as, but is 4-5 times lighter than, 316L stainless steel, and is well-suited for use in all environmental conditions typically specified for tactical terrestrial military ground equipment. The operator then frees one loop of the soft link 307 from the snap hook 308, threads it through the attachment hole on the rod or stake 304, and then back onto the snap hook 308. Once the soft link 307 is secured, the operator applies motive force to the winch 305 (e.g., using a hand crank, power drill, or other device), to wind in the belt 306 to remove any slack in the belt 306. At this point, the belt 306 will be approximately in line with the stake or rod 304, as shown in FIG. 3. It should be appreciated that an operator may fine tune this alignment through by minor adjustments of the puller's position. Although the puller will extract a stake or rod even when the belt 306 is not linearly aligned with the stake or rod, the better the alignment, the easier it is to extract the stake or rod.

After the belt alignment is acceptable, the operator cranks the winch 305 using, for example, a drill or a hand crank, to withdraw the stake or rod 304. Measured belt tension for embodiments of the present approach, under average ground conditions to start the extraction of both guy stakes and ground rods, is approximately 1200 pounds, with this loading progressively reducing to very low values during the process, assuming a Dyneema® belt is used. This is due to the very low belt stretch of the belt (i.e., very little kinetic energy stored compared to high stretch materials), and in particular with Dyneema® belts (or belts and cables formed from other ultra-high-molecular-weight polyethylene materials), coupled with the proportionate reduction of friction between guy stake or ground rod and the ground as they are withdrawn. This proportionate reduction is characteristic of an in-line pull.

Some embodiments may include a safety disc 309 located at or near the free end 312 of the belt 306. Generally, safety disk 309 may take the form of a robust, slotted disc or other object, through which the belt 306 passes. Although shown as a disk, safety disk 309 may take various geometries, provided it does not permit the belt 306 to proceed through the braces 303. For example, the disk may be hexagonal in shape to reduce material costs. To provide a maximum single step pull, the safety disc 309 is positioned near or immediately above the snap hook 308. Safety disc 309 may be sized so that it is too large to pass between the braces 303 in embodiments with at least a pair of braces, or through an incision or hole in embodiments with a single brace. In the unlikely event of violent breakout of guy stake or ground rod during the extraction process, the risk of injury to the operator is substantially mitigated by the safety disc 309, because the guy stake or ground rod is restrained by the safety disk contacting the brace(s) 303. In addition, stakes or rods being extracted are, to a large extent, caged in by the tripod framework of the puller 300 (or support structure in other embodiments), provided that the operator remains in a safe position during use.

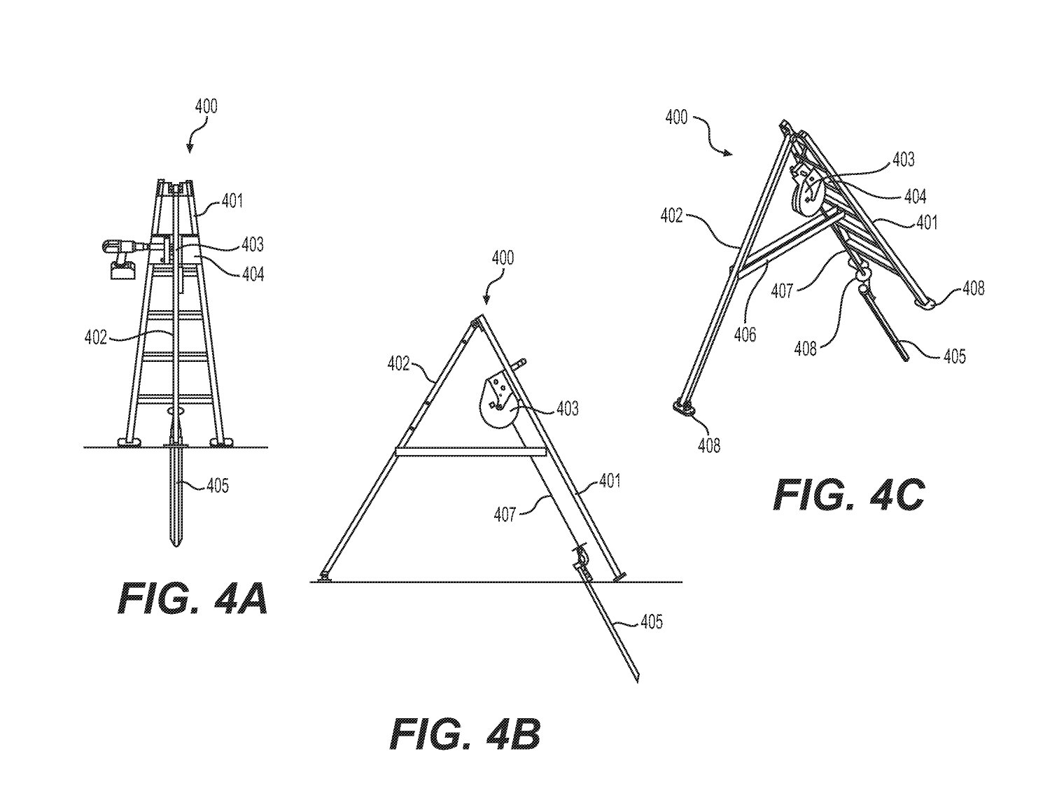

FIGS. 4A-4C show different views of an alternative embodiment of a puller according to an embodiment of the present approach. Puller 400 is formed from a tripod having A-frame 401 hingedly connected to strut 402. The hinged connection allows for adjusting the angle of the tripod to approximate the angle of the rod or stake 405. In this embodiment, a pair of braces 406 extends between A-frame 401 and strut 402, keeping the tripod extended at the desired angle. Belt (or cable) 407 passes between braces 403. It should be appreciated that some embodiments may use a single brace, and provide an incision or hole for belt (or cable) 407. The winch 403 is attached to a cross-member 404 on A-frame 401, and may in some embodiments be attached by quick release fittings. In this embodiment, winch 403 is positioned below the top of puller 400, and on the inside face of the A-Frame 401, such that there is clearance for the strut 402 at the minimum desired operating apex angle. Strut 402 and winch 403 are located symmetrically about the fore and aft axis of the tripod in this embodiment. During operation, the tripod is placed such that the rod or stake 405 to be extracted is within the triangular area formed by the tripod feet 408, and in line with the tripod fore and aft axis. This geometry provides enhanced stability about all degrees of freedom during the extraction process, without any additional intervention by the operator. For example, there is no tendency to tip over, unlike most contemporary pullers. In fact, in this embodiment puller 400 stability increases as belt tension builds during the extraction operation, so that a single operator is free to encourage reluctant rods or stakes with side blows with a sledge hammer, a very effective combination of forces in tough ground conditions.

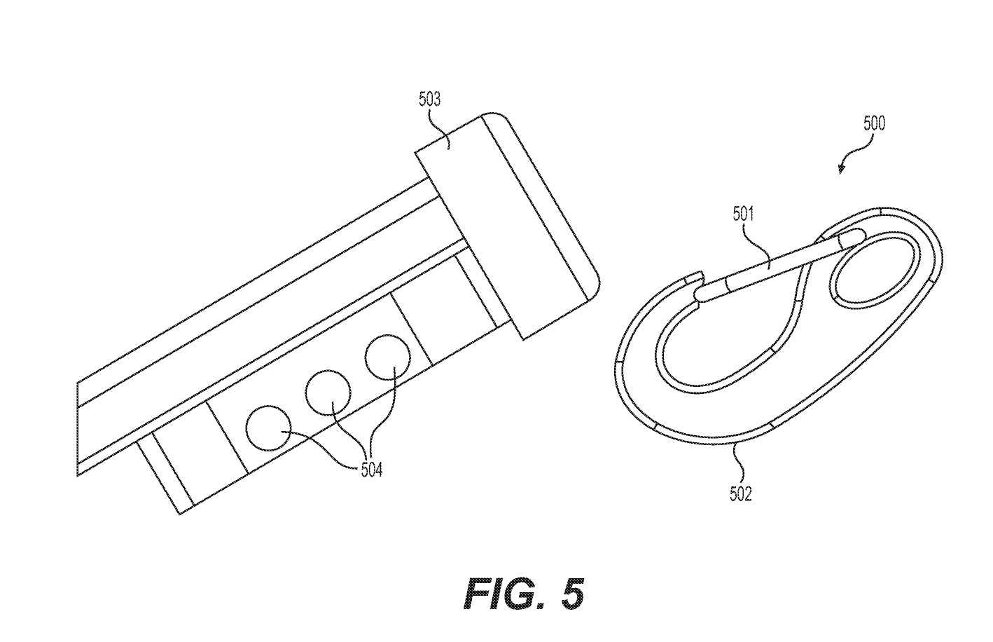

FIG. 5 shows an embodiment of a quick release connection device 500 next to a top portion of a ground rod or guy stake 503. Quick release device 500 includes a snap hook 501 (or other load-bearing clip as may be known in the art, such as a G-clip), connected to a soft link 502. Soft link 502 may be formed from an ultra-high-molecular-weight polyethylene material, such as, for instance, Dyneema®. In this embodiment, soft link 502 is formed as a loop inserted into the snap hook 501, and the loop may be threaded through a hole 504 in stake or rod 503 and then inserted into the snap hook 501 a second time. In this manner, quick release connection device 500 is removably connected to stake or rod 503 and the extraction process may commence. It should be appreciated that alternative shapes, clips, and materials may be used to form a quick release connection device under the present approach.

FIG. 5 demonstrates the advantage of including a soft link between a quick release component and a guy stake. Without the intermediate soft link, a snap hook directly attached to a guy stake will be offset from the direction of the pull, unless the snap hook is exceptionally long (an expensive option). Because the head of a guy stake extends beyond the attachment holes, the snap hook must be rotated for direct connection, and therefore linear alignment of the belt is not possible. The consequence is that force applied by a puller strains and eventually bends the snap hook. However, the soft link avoids this problem.

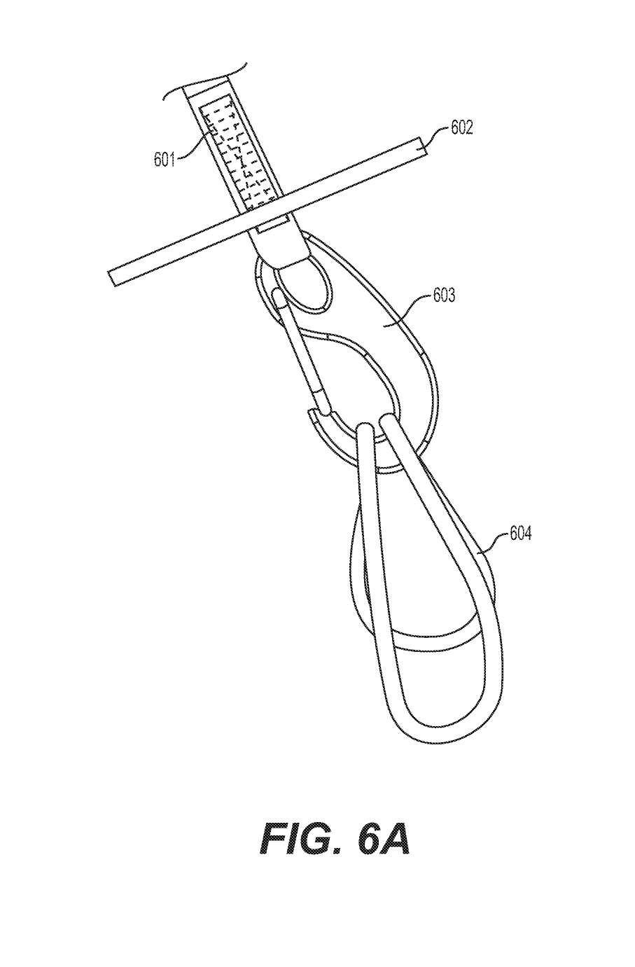

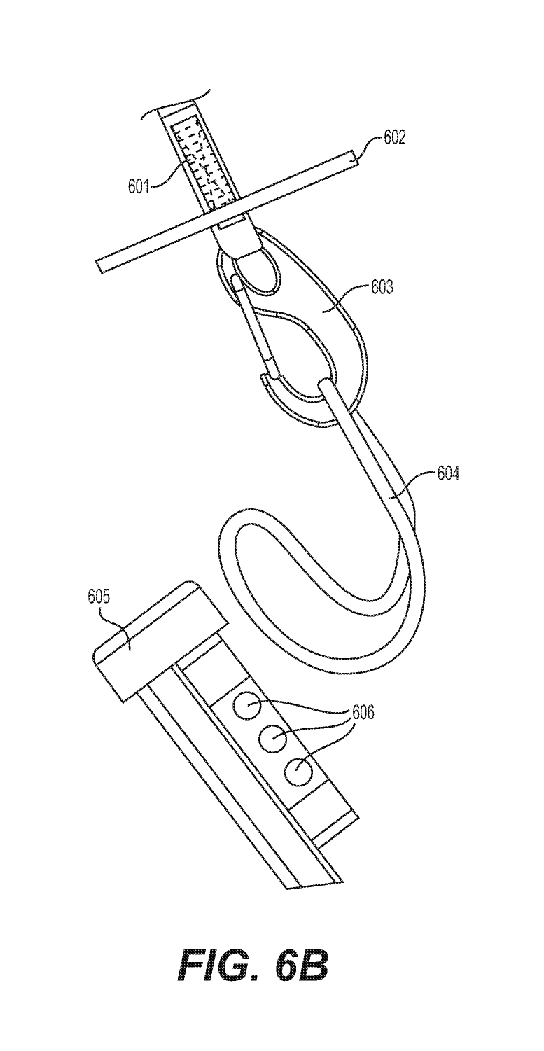

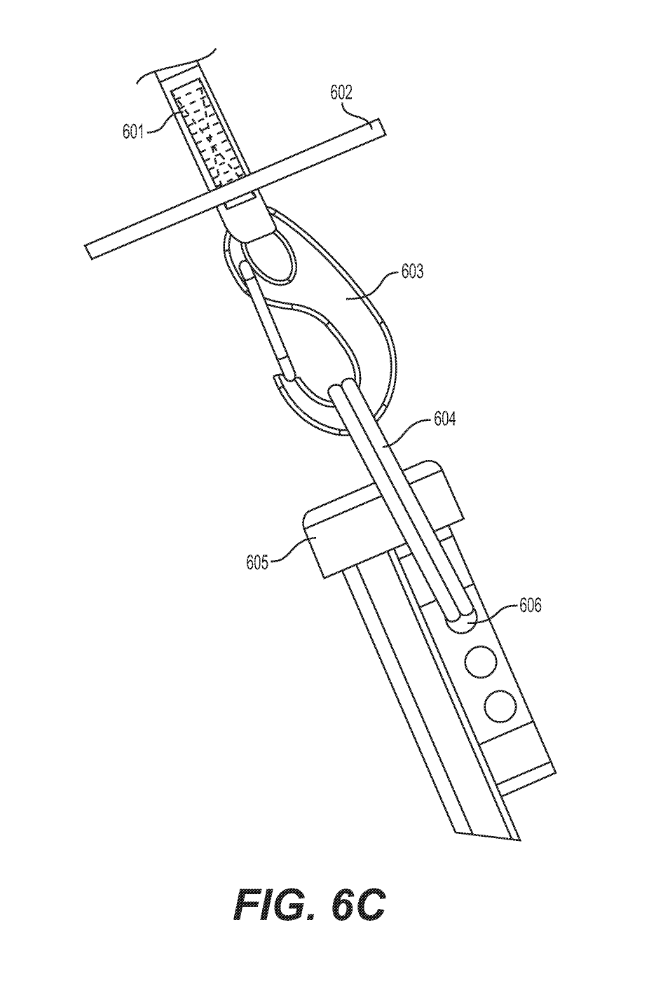

Under the present approach, a soft link may be used to provide linear alignment from a belt (or cable) to a guy stake. FIGS. 6A-6C show a method for using a soft link with a snap hook to linearly align a belt with a guy stake. Belt 601 connects to snap hook 603 after safety disk 602. Soft link 604, formed as a loop, has a first connection about snap hook 603. Soft link 604 may then be threaded through one or more attachment holes 606 on guy stake 605, and then a second connection about snap hook 603 may secure belt 601 into a linear alignment with guy stake 605.

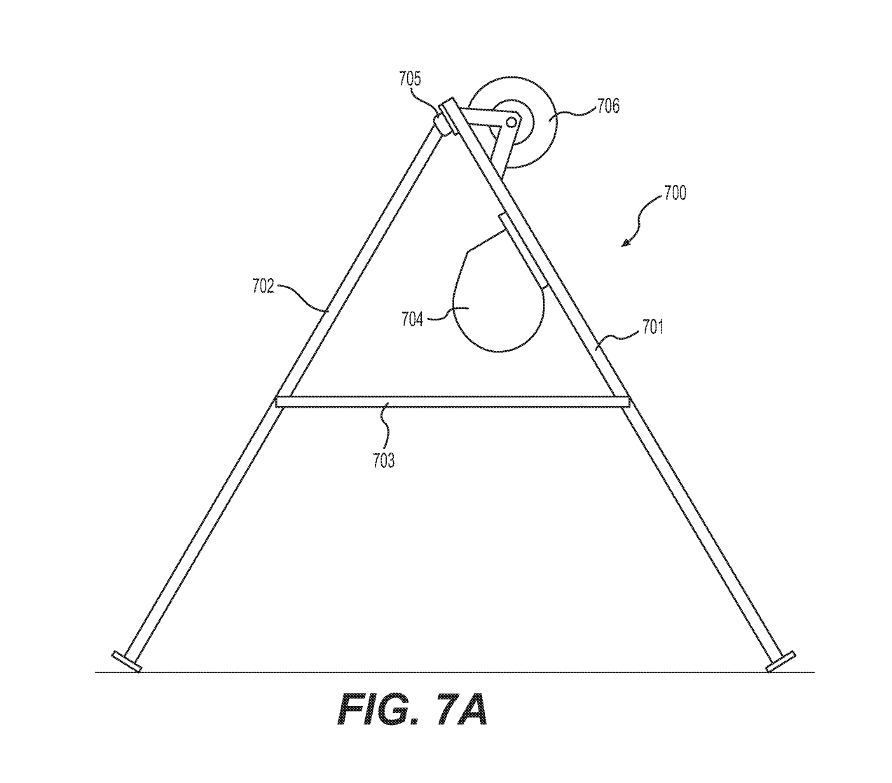

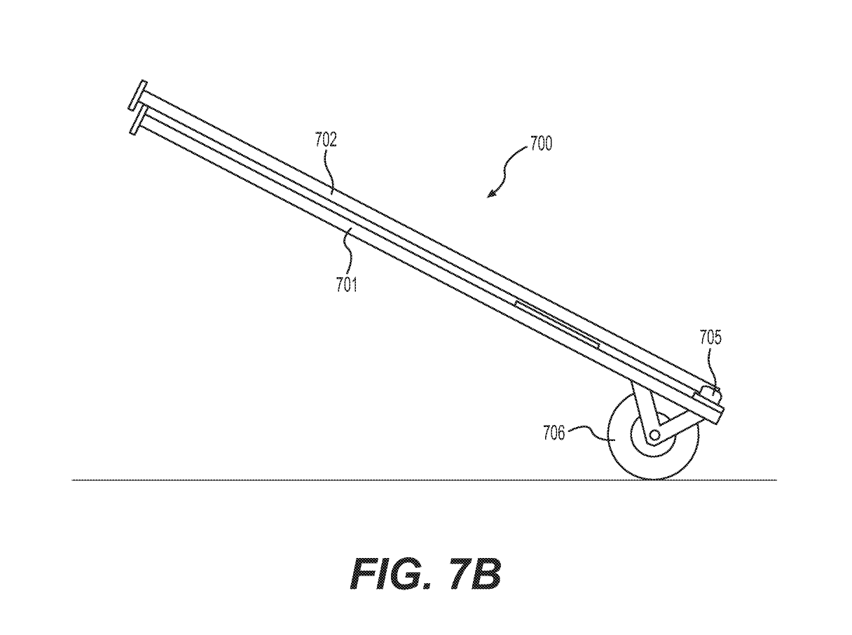

Some embodiments of the present approach may feature one or more wheels to permit easy movement and additional utility. It should be appreciated that one or more wheels may be included on locations other than as shown, as may be desired for a particular embodiment. FIGS. 7A and 7B show an embodiment of a puller having a wheel attached to the A-frame. Puller 700 includes A-frame 701 connected to strut 702 about hinge 705. In FIG. 7A, puller 700 is configured for use, and one or more braces 703 secure puller 700 at the desired angle. Wheel 706 is connected to an upper end of A-frame 701, and in this embodiment above winch 704. As shown in FIG. 7B, puller 700 may be collapsed after brace(s) 703 are unlocked and winch 704 is removed. Strut 702 folds about hinge 705 to be flush with A-frame 701. An operator may then carry the legs of the A-frame 701, and operate the folded puller 700 similar to a wheelbarrow. Indeed, some embodiments may be configured with additional surface area and/or structures to support using the folded puller 700 as a wheelbarrow.

Some embodiments of the puller device described herein may be provided in the form of a simple kit. For example, temporary, emergency, or tactical military communications and electronics equipment systems frequently include one or more drills and one or more winch systems. Thus, a mounting structure having an A-frame, strut, and one or more braces as described herein, may be provided, along with a quick release adapter for removably connecting the winch to the A-frame. The kit may also include a belt or cable configured for extracting ground rods and guy stakes as described herein.

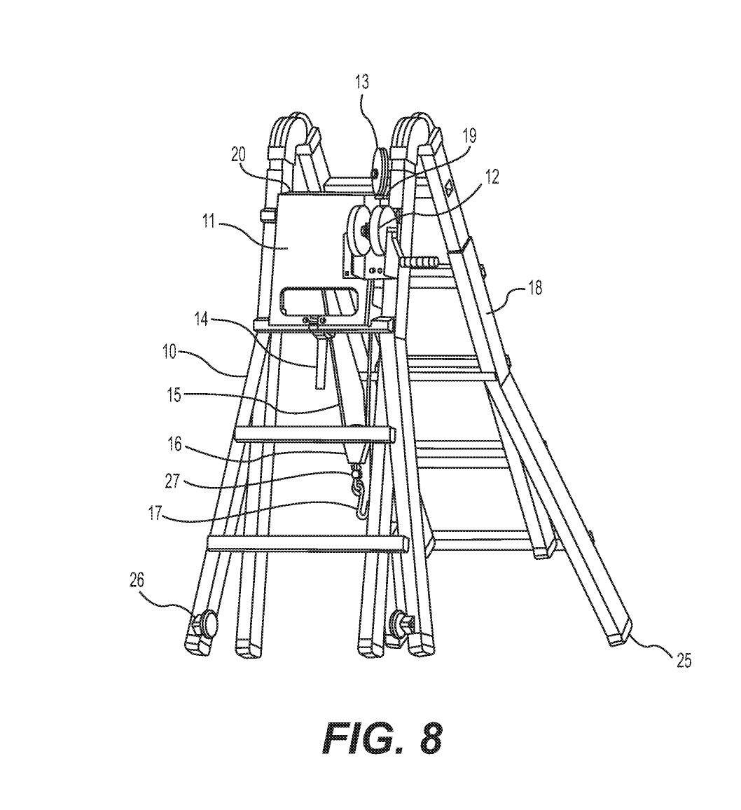

FIGS. 8-12 show a preferred embodiment of the present approach wherein the support structure is an extending stepladder 10. This embodiment may be mounted onto a robust extendable step ladder 10, such as one available at common hardware stores and frequently used in military applications. Generally, as long as the item being extracted from the ground lies close to the ladder 10 centerline, and within the area bounded by the ladder feet 25, the entire system remains stable throughout the extraction process. Once the winch 12 is cranked, the pull force generated due to the cable tension holds the ladder 10 firmly in place, no matter what the slope of the ground, or whether or not the operator is holding onto it. This is another major benefit of the present approach compared to prior art.

Advantageously, this embodiment allows for easy adjustment to achieve the desired operating angle. Extension of the legs 18 on only one side of the ladder 10 may be used to vary the angle made between the ladder legs 18 and the ground, compared to when the legs 18 are of equal length. Also, the angle of the articulable joint of ladder 10 may be adjusted, depending on the specific ladder used in the embodiment.

This feature provides the benefit that a wide range of pull angles (with respect to the ground) may be accommodated by simply extending or retracting one side of the ladder. This is another benefit of the present approach not found in prior art.

A hand winch 12, such as those manufactured by the Dutton-Lainson company, is bolted close to the right-hand edge of the mounting plate 11 at a convenient height for the operator, and in such a way that the winch handle is well clear of obstructions throughout its travel. Of course, other winches may be used without departing from the present approach. It should be appreciated that in other embodiments, mounting plate 11 may be removable attached to support structure 10, such that a user may use support structure 10 for other purposes when the unit is not being used for extraction purposes.

The winch cable 15 is routed upwards from the winch 12 through a fairlead 19 and passes over a pulley 13, referred to hereinafter as the top pulley 13, secured to a top surface of the mounting plate 11. It should be appreciated that alternative mounting locations for the top pulley 13 are possible without departing from the present approach. The cable used in the preferred embodiment is fabricated from Dyneema. The significant advantage of Dyneema compared to other cable materials (such as steel) for this application is that there is no tendency to whip or spring back in the event of a break in the line under high tension, or if the guy stake or ground rod being extracted suddenly breaks loose out of the ground.

Once the cable 15 has passed over the top pulley 13, it may be routed down between the legs 18 of the ladder 10, pass through a pulley block 16, hereinafter referred to as the lower pulley 16, then back up to a hard point 20 on an upper surface of the mounting plate 11, to which cable 15 may be securely attached.

The location of the hard point 20 may be such that, from a bird's eye view from above, the cable 15 forms a symmetrical Vee between the hard point 20, lower pulley 16, and the top pulley 13. This configuration balances out the twist force which is induced by the offset location of the winch 12 (necessitated by the need for handle clearance), while effectively doubling the mechanical advantage of the winch at the start of the pulling operation, when the stake or rod is buried most deeply in the ground, and therefore requires the most force to move.

In this demonstrative preferred embodiment, the location, size, and orientation of the top pulley wheel 13 may be chosen to provide one or more of the following desired benefits:

a) the top pulley 13 may be located at the highest point practicable to provide the maximum possible “single step” pull distance.
b) seen from the side, pulley 13 diameter may be greater than the width of the ladder leg 18, so that the cable 15 may be run parallel to, and on the inside of, the ladder leg closest to the operator. This geometry permits a vertical pull without interference between item being extracted and the ladder.
c) seen from above, the top pulley 13 may be mounted at an angle to the fore and aft axis of the open ladder 10 to permit the cable to form the Vee described above without chafing.

An S-hook 17 may be attached to the lower pulley 16 via a shackle 27. The S-hook 17 provides rapid, secure attachment to, and rapid disengagement from, the item being extracted from the ground. Wheels 26 on the ladder 10 permit the entire assembly to be easily relocated by one person as needed.

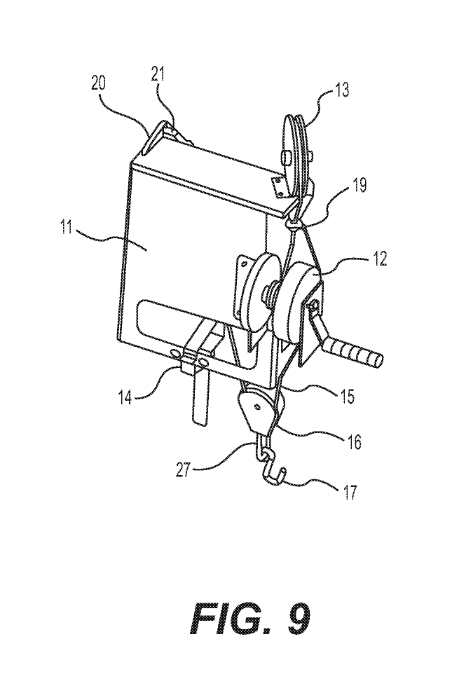

FIG. 9 shows a detailed view of an embodiment of mounting plate 11 and winch 12 without the ladder 10 or other support structure. Using the quick release strap 14, this self-contained apparatus can be secured to, or removed from, the ladder (or other support structure) without the need for tools, and without permanent modification of the ladder. This view shows the hard point 20, and snap hook 21, used to secure the end of the cable 15 to the mounting plate 11. It can be seen that the winch assembly in this embodiment is configured for looping a cable 15 in a Vee configuration, from hardpoint 20, to lower pulley at pulley block 16, and to top pulley 13.

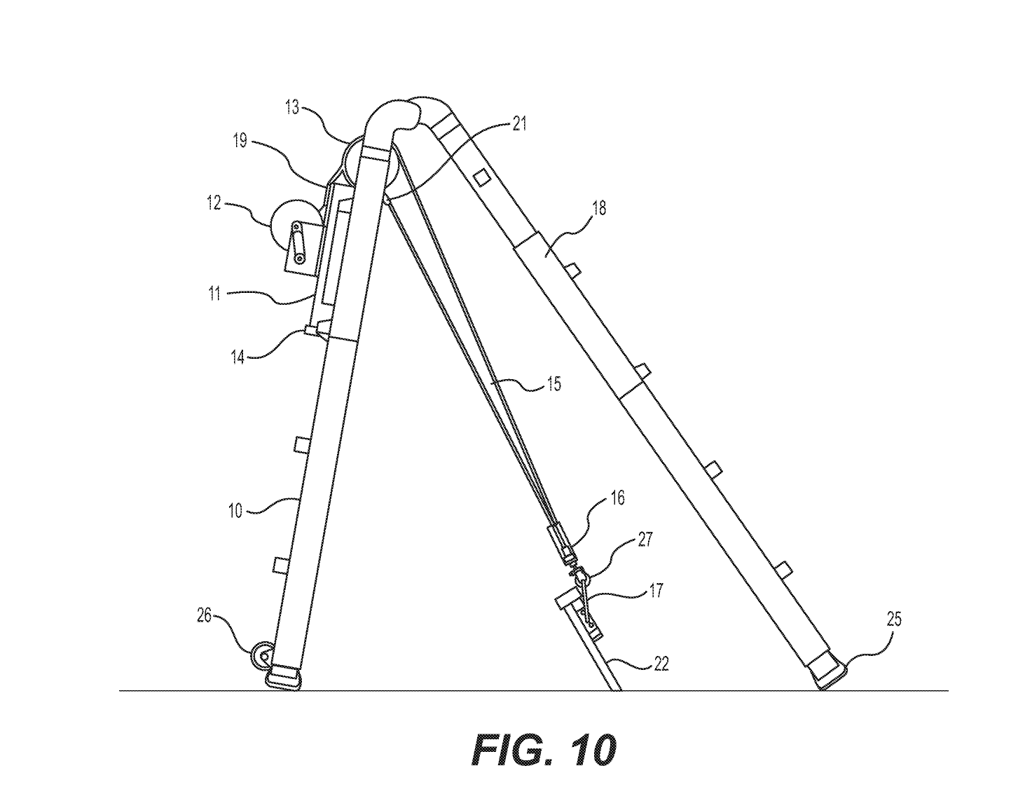

FIG. 10 shows this preferred embodiment being used to extract a guy stake 22 driven at approximately 60 degrees to the horizontal. The forward ladder legs 18 have been extended by about twelve inches (one rung) to obtain a pulling angle in line with the angle of the stake. It should be appreciated by those skilled in the art that an adjustable support structure, such as an extendable ladder 10, may be used in this manner to achieve an optimum pulling angle.

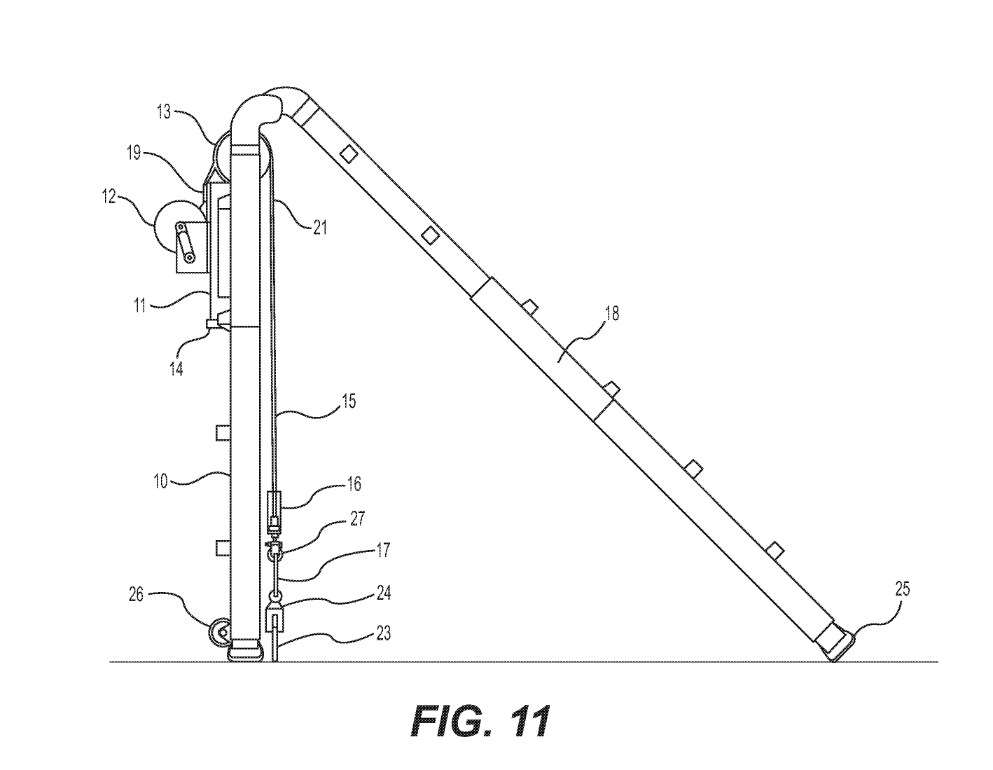

FIG. 11 shows a preferred embodiment being used to extract a ground rod 23 driven at 90 degrees to the horizontal. The support structure (ladder 10) may be placed such that the ladder legs closest to the operator are immediately adjacent to the ground rod. The S hook 17 is attached to an eye nut 24 screwed onto the top of the ground rod 23. The forward ladder legs 18 are extended by about 24 inches (two rungs) to cause the rear legs to be vertical, providing the maximum possible vertical travel of the ground rod 23 from the start condition. This approach may be used to reduce the number of separate pulls necessary to extract a ground rod 23 in a particular instance.

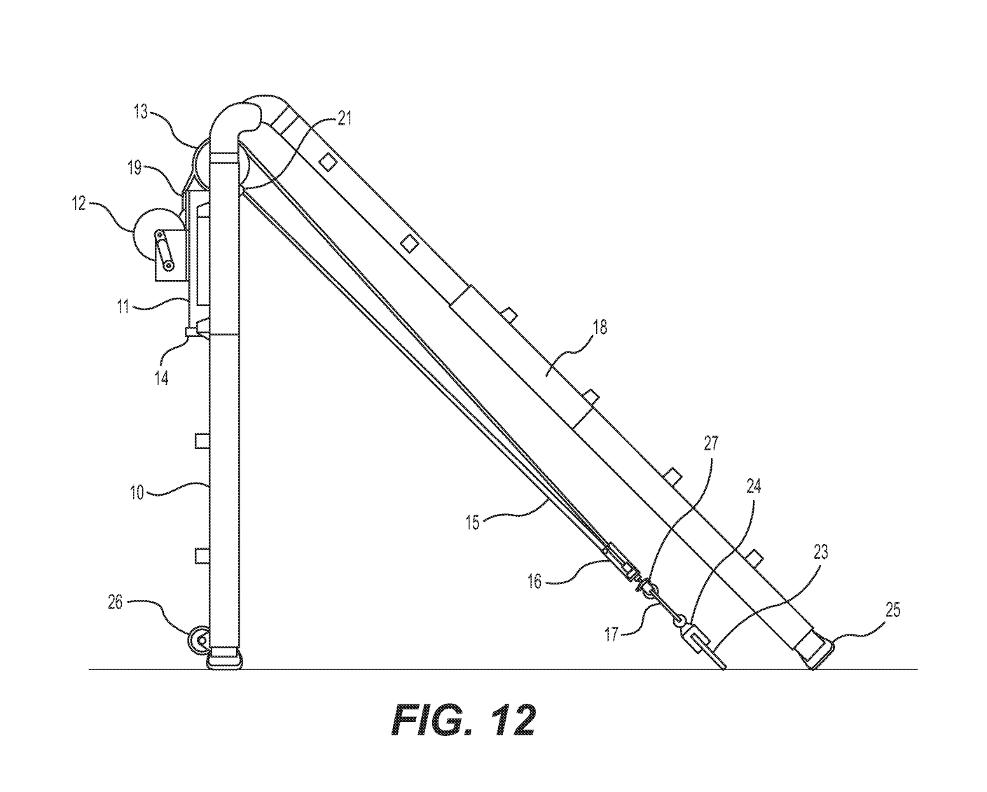

FIG. 12 shows the preferred embodiment being used to extract a ground rod 23 driven at 45 degrees to the horizontal. The ladder 10 is placed such that the ladder legs furthest from the operator are immediately adjacent to the ground rod. These forward ladder legs 18 may extended by the same amount as described above, making an angle of approximately 45 degrees to the ground.

Some embodiments may have a pannier attached to the support structure. The pannier provides convenient temporary storage of ground rods and guy stakes following extraction.

The invention may be embodied in other specific forms without departing from the spirit or essential characteristics thereof. The disclosed embodiments are to be considered in all respects as illustrative and nor restrictive, the scope of the invention being indicated by the claims of the application rather than by the foregoing description, and all changes which come within the meaning and range of equivalency of the claims are therefore intended to be embraced therein.

We claim the following:

1. A ground rod and stake extractor comprising:
a support structure having an upper end with an articulable joint and a plurality of legs extending downward from the articulable joint;
a winch assembly mounted to an upper portion of the support structure and including a winch;
a cable assembly operatively connected to the winch assembly and having an extraction segment extendable downward and configured for connection with at least one of a ground rod and a guy stake.

2. The ground rod and stake extractor of claim 1, wherein the support structure comprises an extendible ladder.

3. The ground rod and stake extractor of claim 1, wherein the support structure comprises a tripod with an A-frame connected to a strut at the articulable joint.

4. The ground rod and stake extractor of claim 1, wherein each leg includes a lower end opposite the articulable joint, and the cable assembly extraction segment is extendable downward from the winch assembly within an area defined by the legs' lower ends.

5. The ground rod and stake extractor of claim 1, further comprising a first leg adjustable at the articulable joint between 0° and about 350° relative to a second leg.

6. The ground rod and stake extractor of claim 1, wherein the length of at least one leg is adjustable.

7. The ground rod and stake extractor of claim 1, further comprising at least one wheel connected to at least one leg.

8. The ground rod and stake extractor of claim 1, further comprising a variable brace to adjustably secure a first leg relative to a second leg.

9. The ground rod and stake extractor of claim 1, wherein the winch assembly is removably mounted to the support structure.

10. The ground rod and stake extractor of claim 9, wherein the winch assembly includes a quick release strap for removably mounting the winch assembly to the support structure.

11. The ground rod and stake extractor of claim 1, wherein winch assembly further comprises a mounting plate mounted to the support structure and the winch connected to the mounting plate.

12. The ground rod and stake extractor of claim 11, wherein the mounting plate is removably mountable to the support structure.

13. The ground rod and stake extractor of claim 1, wherein winch assembly comprises one of a hand winch and a motorized winch.

14. The ground rod and stake extractor of claim 1, wherein the cable assembly's extraction segment is connected to one of a snap hook and a soft link.

15. The ground rod and stake extractor of claim 14, wherein the soft link comprises a loop formed from an ultra-high molecular weight polyethylene material.

16. The ground rod and stake extractor of claim 14, wherein the cable assembly's extraction segment is connected to a load-bearing clip connected to a soft link formed from an ultra-high molecular weight polyethylene material.

17. The ground rod and stake extractor of claim 1, wherein the cable assembly comprises one of a cable and a belt.

18. The ground rod and stake extractor of claim 1, the winch assembly further comprising an upper surface having a connection point on a first side of the upper surface and an upper pulley on a side of the upper surface opposite from the first side;
wherein the cable assembly extends from the upper pulley downward to a lower pulley positioned between the upper pulley and the connection point when viewed from above, the cable assembly further extending upward from the lower pulley such that a cable assembly free end connects to the connection point.

19. The ground rod and stake extractor of claim 1, wherein the cable assembly includes a safety disc attached near the extraction segment.

20. A method for extracting one of a ground rod and a guy stake, the method comprising:
positioning a support structure over one of a ground rod and a guy stake, the support comprising an articulable joint and a plurality of legs extending downward from the articulable joint, each leg having an end opposite the articulable joint such that the leg ends define an extraction area, the one of a ground rod and a guy stake extending at an extraction angle from the ground within the extraction area;
connecting a cable assembly's extraction segment to the one of a ground rod and a guy stake, the cable assembly extending from a winch assembly mounted to an upper portion of the support structure;
adjusting at least one leg such that the at least one leg's angle relative to the ground is approximately the extraction angle;
operating the winch assembly to extract the one of a ground rod and a guy stake at the extraction angle.
